(19) United States
(12) Patent Application Publication
(10) Pub. No.: US 2020/0039018 A1
(43) Pub. Date: Feb. 6, 2020

(54) Apparatus and Method for Supporting and Severing an Object of Interest

(71) Applicant: Chris Henjum, Spokane Valley, WA (US)

(72) Inventor: Chris Henjum, Spokane Valley, WA (US)

(21) Appl. No.: 16/054,032

(22) Filed: Aug. 3, 2018

(51) Int. Cl. B23Q 17/24; B23Q 15/14; B23K 7/00; B23K 37/04

(52) U.S. Cl. CPC B23Q 17/2414; B23Q 17/2471; B23K 37/0408; B23K 7/002; B23Q 15/14

(57) ABSTRACT

An apparatus and method for supporting and severing an object of interest is described and which includes a frame for positioning an object of interest which is to be severed; a cutting device which is selectively mounted in spaced relation relative to the frame; a multiplicity of orientation units mounted on the frame and which are adjustable, as to length, to maintain the object of interest in a predetermined orientation while being severed; and a controller operably coupled to each of the cutting device, and orientation units, so as to effect an optimal severing of the object of interest while maintaining the object of interest in a given planar orientation on the frame.

### TECHNICAL FIELD

The present invention relates to an apparatus, and method for supporting and severing an object of interest, and more specifically, to an apparatus which supports a rigid, yet flexible material that is to be severed, in a predetermined planar orientation, and thereafter controllably moves a cutting device, in a given manner, so as to sever a predetermined region of the object of interest while simultaneously maintaining the object of interest in the given predetermined planar orientation.

### BACKGROUND OF THE INVENTION

Various machines have been developed, and have been commercially deployed through the years, and which are useful for severing or otherwise cutting objects of interest which are often presented or provided in the form of a substantially continuous rolls. The material which is formed into the aforementioned roles to be selectively severed may include various metals, synthetic materials, and the like.

The prior art attempts to provide a means for severing a ridged, yet flexible and continuous object of interest have taken on various forms. For example, the Office's attention is directed to International Publication No. WO 2012/002801 A1, to the Applicant Therp Holding BV, and which relates to a work piece support for supporting a generally plate-like work piece for processing by a thermal cutting tool. In the aforementioned International publication, the Applicant discloses an invention for supporting a generally plate-like work piece which includes a plurality of rows of supporting elements which are movable between a supporting position, and where they support the work piece, and a non-supporting position where they do not support the work piece, and a processing unit is provided to control the movement of the supporting elements based upon the position of a thermal cutting tool which is employed with same. In this arrangement, the work piece supporting elements comprise, at least in part, an electromagnet arranged to perform the individual movement between either the supporting position, or the non-supporting position. The aforementioned reference goes into some detail regarding the problems associated with the prior art attempts to sever either flexible, or smaller sized objects of interest using cutting tools as described, above.

While theoretically, a device as described in the aforementioned International Publication should be able to support a flexible material in a manner such that accurate severing or cutting of same can be accomplished, it is well known that the use of electromagnets arranged in the manner, as described, to perform the individual movements has proven, overtime, to be less than ideal in maintaining flexible substrates, and other objects of interest, such as thin sheets of metal, in a predetermined, planar orientation so as to allow precise severing or cutting of the flexible material to take place. Further, the use of magnetically actuated supporting elements has repeatedly proven to be problematic when the object of interest to be severed is also a magnetically attractive material. In this regard the debris which is often generated by the cutting or severing process often becomes adhered to the adjustable and magnetically driven support member thereby causing them to individually malfunction, over time. Consequently, the adjustment of the magnetically driven support members has proven to be problematic based upon the composition of the object of interest which is being severed. As will be appreciated, a failure to maintain an object of interest to be severed, in a proper planar orientation, results in a severing or cutting of the object of interest which is often less than accurate because of the non-planar orientation of the object of interest being severed. Furthermore, the repeated exposure of magnetic support assemblies as described in the prior art to a high temperature environment such as might be occasioned by exposure of the magnetic support members to the thermal temperatures occasioned by the operation of a thermal cutting tool often has resulted in the inaccurate positioning of the magnetic support member relative to the object of interest being severed. This, again, has created inaccurate cuts being made in the objects of interest being severed. Finally, the use of magnetic support members has proven to be less than ideal because the fine adjustment of the length dimension of each of the magnetic support members has been often difficult to achieve especially if cutting debris adheres to the respective magnetic support members.

Therefore, a method and apparatus for supporting and severing an object of interest which avoids the problems and detriments associated with the prior art teachings utilized, heretofore, is the subject matter of the present invention.

### SUMMARY OF THE INVENTION

A first aspect of the present invention relates to an apparatus for supporting and severing an object of interest which includes a frame for positioning an object of interest, which is to be severed, in a given, predetermined, planar orientation; a cutting device which is selectively, and moveably mounted in spaced relation relative to the frame, and which, when rendered operable, severs the object of interest which is positioned in the predetermined, planar orientation on the frame; a multiplicity of orientation units which are mounted on the frame, and which are further selectively, and mechanically adjustable, as to length, so as to individually position, and maintain the object of interest to be severed in the predetermined, planar orientation while being severed; and a controller, operably coupled with each of the cutting device, and multiplicity of orientation units, so as to effect an optimal severing of the object of interest while maintaining the object of interest in the predetermined planar orientation on the frame, and which further simultaneously, and selectively displaces the individual orientation units from a supporting position relative to a region of the object of interest where the cutting device is currently severing the object of interest.

Another object of the present invention relates to an apparatus for supporting and severing an object of interest which includes, a frame for positioning an object of interest, which is to be severed, in a given planar orientation; a gantry borne by frame, and which is selectively moveable along a predetermined, first course of travel relative to the frame; a cutting device mounted on the gantry, and which is further selectively moveable along the gantry, and in a predetermined, second course of travel which is transverse to the first course of travel of the gantry, and wherein the cutting device, when rendered operational, severs the object of interest which is located on the frame, and positioned between the frame, and the cutting device which is movably mounted on the gantry; a plurality of sensors mounted on the frame, and which are further rendered operable to sense the given planar orientation of the object of interest relative to each of the frame, and the cutting device, respectively; a multiplicity of orientation units which are mounted on the frame, and which are further selectively adjustable as to length so as to individually position, and maintain the object of interest to be severed in the predetermined planar orientation while being severed; and a controller, operably coupled with each of the moveable gantry, cutting device, respective sensors, and multiplicity of orientation units, so as to effect an optimal severing of the object of interest while maintaining the object of interest in the predetermined planar orientation on the frame, and simultaneously withdrawing individual orientation units from a supporting orientation relative to a region of the object of interest, and where the cutting device is severing the object of interest.

Still further, a method for supporting and severing an object of interest includes the steps of, providing a source of an object of interest to be selectively severed; providing a frame which has top and bottom surfaces, and a peripheral sidewall, and which further defines an internal cavity, and supporting at least a portion of the source of object of interest to be severed in a given, predetermined planar orientation relative to the top surface of the frame; providing a multiplicity of orientation units, and spatially positioning the respective orientation units in predetermined locations within the internal cavity of the frame, and wherein the respective orientation units each include an elongated, generally cylindrically shaped, and selectively, mechanically moveable, actuator which supports, at least in part, a discrete region of the object of interest which is positioned on the frame; providing a gantry, and moveably mounting the gantry for travel along a first path of travel relative to the frame, and in predetermined, spaced relation relative to the top surface of the frame; moveably mounting a cutting device on the moveable gantry, and rendering the cutting device selectively moveable along a second, predetermined path of travel which is transverse to the first predetermined path of travel; positioning a plurality of sensors on the frame and/or moveable gantry, and sensing, with the respective sensors, the vertical and horizontal position of at least one of the regions of the object of interest which is supported on the frame; providing a controller, and controllably coupling the controller to each of the multiplicity of orientation units; the moveable gantry; the cutting device, and the respective sensors; sensing with the sensors the horizontal and vertical position of the object of interest, and supplying the horizontal and vertical position of the object of interest to the controller; selectively energizing the respective orientation units, by way of the controller, to adjustably effect, and then maintain the position of the object of interest in the given, predetermined planar orientation on the frame by selectively moving the actuator of individual orientation units so as to impart force to the object of interest, and thereby position the object of interest in the predetermined planar orientation; controllably propelling the gantry along the first course of travel to a given location as determined by the controller; controllably propelling the cutting device along the second course of travel to a given region of the object of interest which is to be severed, as determined by the controller; controllably withdrawing, by means of the controller, the actuator of individual orientation units which are supporting the object of interest, and which are further located in a predetermined vicinity of the region of the object of interest which is to be severed, and positioning the respective actuators in spaced relation relative to region which is to be severed; selectively and operably energizing the cutting assembly by way of the controller, and severing the object of interest in a predetermined pattern in the region of the object of interest as determined by the controller by simultaneously, and controllably propelling the gantry along the first course of travel, and the cutting assembly along the second course of travel; and after the step of severing the object of interest, selectively, and controllably repositioning, by means of the controller, the actuator of individual orientation units which were previously withdrawn, and located in spaced relation relative to the region of the object of interest which was previously severed, so as to maintain the object of interest in the predetermined planar orientation relative to the frame.

These and other aspects of the present invention will be discussed in greater detail hereinafter.

### BRIEF DESCRIPTION OF THE DRAWINGS

Preferred embodiments of the invention are described, below, with reference to the following accompany drawings.

FIG. 1 is a perspective, side elevation view of an apparatus incorporating the subject matter of the present invention.

FIG. 2 is a fragmentary, perspective view of a support frame which forms one of the features of the present invention.

FIG. 2A is a fragmentary, greatly enlarged view of a portion of the support frame as depicted in FIG. 2A

FIG. 3 is a fragmentary, perspective, greatly enlarged, side elevation view of an orientation unit which forms a feature of the present invention.

FIG. 4 is a greatly enlarged, side elevation view of the orientation unit as seen in FIG. 3, and supporting an object of interest which is being severed.

FIG. 5 is an exploded, greatly enlarged, perspective, side elevation view of the orientation unit as illustrated in FIGS. 3 and 4, respectively.

FIG. 6 is a greatly simplified, schematic view of the major components of the present invention, and their operational relationships, one relative to the others.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

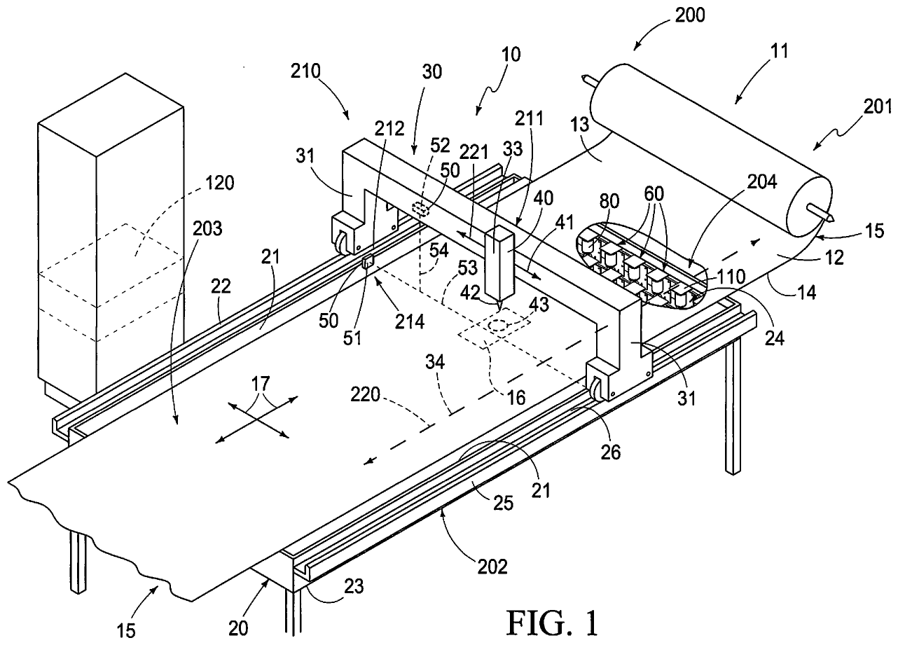

The apparatus of the present invention is generally indicated by the numeral 10, in FIG. 1, and following. As seen in FIG. 1, it will be understood that the present invention includes a source of an object of interest to be severed, and which is generally indicated by the numeral 11. In one possible form of the invention, the source 11 can be formed into a substantially continuous roll which then produces a flexible, continuous sheet 12, and which further is then supplied or provided to a frame, as will be discussed in greater detail, below. The frame supports the object of interest to be severed 11 in a predetermined planar orientation 17 as described, hereinafter. As seen in the drawings, the object of interest to be severed 11, and which may be supplied in a continuous sheet 12, is defined by a top surface 13, and further has an opposite, bottom surface 14. The object of interest to be severed 11 could comprise, for example a metal having a given thickness, or other synthetic material that requires severing in a predetermined pattern. Because the thickness of the object of interest 11 to be severed may be quite thin, the object of interest may possess some degree of flexibility as indicated by the numeral 15 in FIG. 1. Thus the continuous sheet 12 may sag or otherwise assume a non-planar orientation if it is not supported from a location below the bottom surface 14. The object of interest to be severed 11 is defined, at least in part, by a smaller region 16, and within which severing operations take place by the means which are disclosed herein.

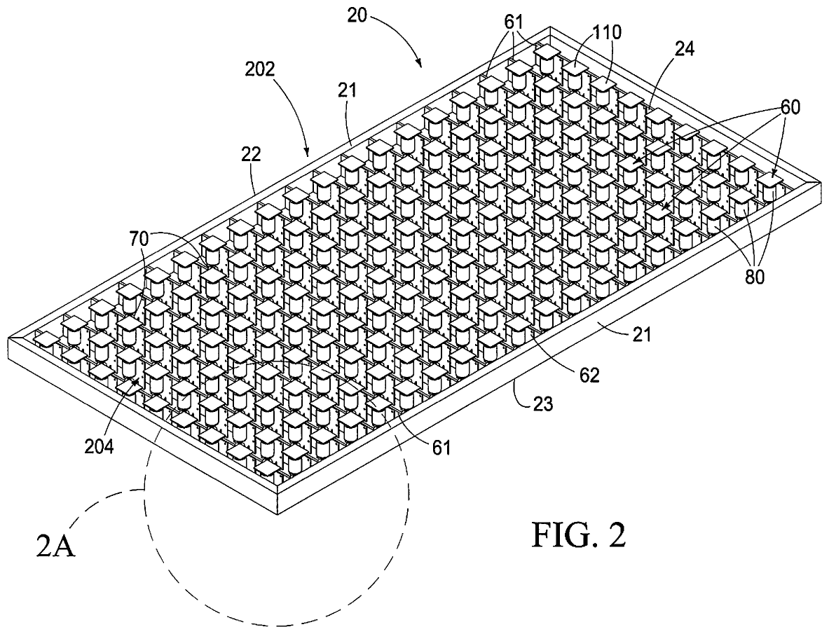

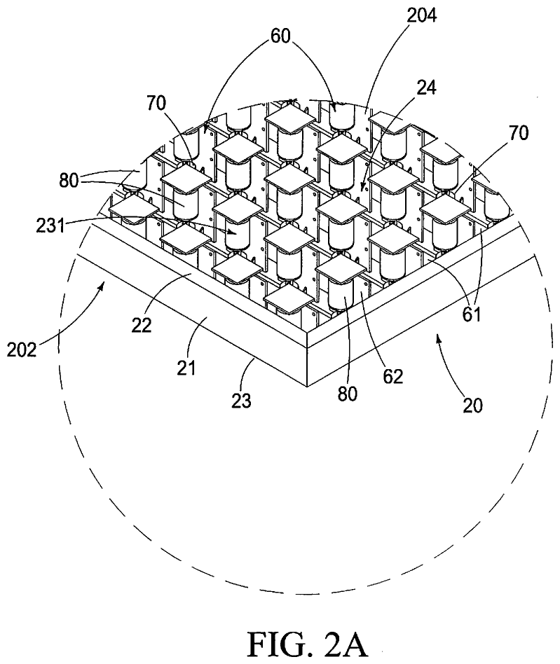

As seen in FIG. 1, the present apparatus 10 includes a frame which is generally indicated by the numeral 20, and which further is used for positioning the object of interest 11 which is to be severed in a given substantially planar orientation which is defined by the numeral 17 as seen in that view. The frame 20 is defined, at least in part, by a circumscribing peripheral sidewall 21. The surrounding, peripheral sidewall has a top surface or edge 22, an opposite bottom surface, or edge 23, and opposite ends. The peripheral sidewall 21 further defines, at least in part, an internal cavity 24 having given length, width and depth dimensions. As seen in FIG. 1, a drive rail 25 is mounted on each of the spaced, and opposed peripheral sidewalls 21. Each of the respective drive rail 25 defines a channel 26, and within which a movable gantry travels. The movable gantry will be discussed in the paragraphs which follow. As illustrated in FIG. 2, the frame 20 is generally illustrated as being rectangular in shape although it is conceivable that other shapes will work with an equal degree of success.

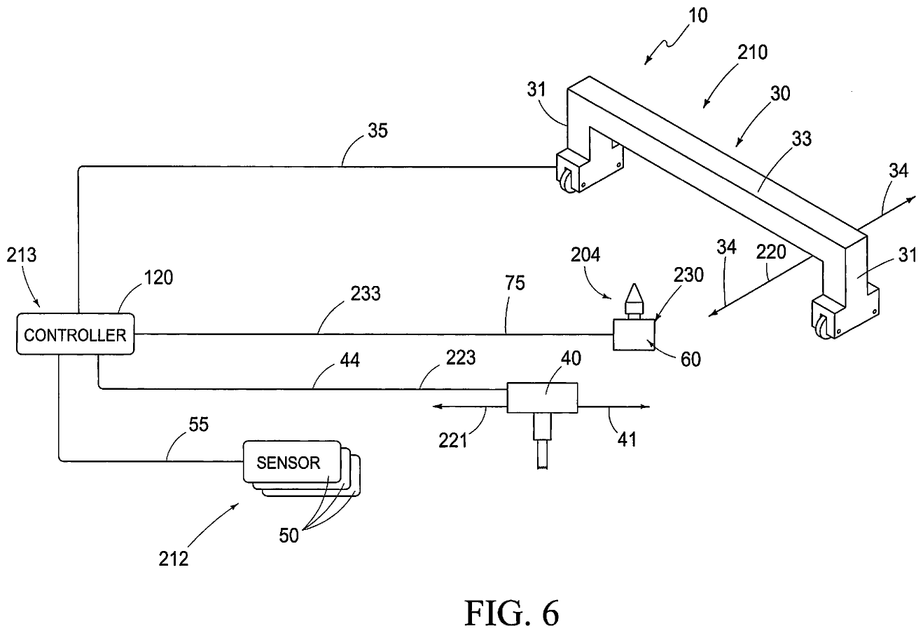

The apparatus 10 of the present invention includes a movable gantry and which is generally indicated by the numeral 30. The movable gantry is defined, at least in part, by a pair of spaced, and generally vertically oriented support members 31. The pair of vertically oriented support members 31 each have a drive rail engagement member 32 fixed thereon, and which rests within, and rollably engages the drive rail 25 which is mounted on each of the opposite, peripheral side walls 21 of the frame 20. Still further, the gantry 30 includes a cutting assembly support member 33 which is mounted, on its opposite ends, to one of the vertical support members 31. The support member 33 is rendered operable to movably support a cutting assembly, as will be described, below, for selective movement or travel therealong the support member 33. The gantry 30, as seen in FIGS. 1 and 6 is selectively, reciprocally movable along a first path of travel, and which is generally indicated by the line labeled 34, along the respective drive rails 25. As seen in FIG. 6, an electrical pathway 35 couples the movable gantry 30 to the controller as will be described, hereinafter, thereby allowing the controller to selectively move or position the gantry 30 along the first path of travel 34. The operation of the preferred embodiment of the present invention will be discussed in greater detail, hereinafter.

A cutting device 40 is generally indicated in FIG. 1, and following. The cutting device may comprise, at least in part, a cutting device which emits a high pressure fluid stream which severs the object of interest 11, or on the other hand, the cutting device 40 comprises a well-known thermal cutting tool which severs the object of interest. Thermal cutting tools of various types are well known in the art, and further detail regarding their structure and operation is not warranted. The cutting device 40 is movable along a second path of travel 41, and which is disposed in a generally transversely disposed orientation relative to the first path of travel 34, and which was described, above, for the movable gantry 30. The cutting device 40 has a cutting head 42, which emits or provides a cutting media of a given type which is directed at a region 43 which is being severed from a smaller region 16 of the object of interest 11. As seen in FIG. 6, the cutting device 40 is controllably coupled by means of an electrical pathway 44 to a controller, and which will be described in greater detail, below. The cutting device 40 is selectively movable along the support member 33 by the control signals sent by the aforementioned controller so that complex patterns may be severed from the continuous sheet 12 as it rests in its given planar orientation 17 upon the frame 20, as earlier described.

The present invention 10 includes a plurality of sensors 50 which may be mounted either on the frame 51, or on the movable gantry 52. The frame mounted sensors 51 are typically operable to emit an optical beam 53 which determines the horizontal orientation of the top surface 13, of the continuous sheet 12 as it rests upon the frame 20. Still further, the gantry 30 mounted sensors 52 are typically rendered operable to emit an optical beam 54 which determines the vertical orientation of the top surface 13 of the continuous sheet 12 that rests on the frame 20. While two sensors 51 and 52 are shown, it should be understood that multiple sensors will be deployed in various locations both on the frame 20, as well as the movable gantry 30 so as to provide information to a controller, as will be described, hereinafter, regarding the precise planar orientation 17 of substantially the entire upwardly facing surface area 13 of the continuous sheet 12 as it rests on the frame 20. This feature of the invention 10 provides a convenient means by which precise cutting or severing of the object of interest 11 may be secured in a manner not possible, heretofore. An electrical pathway 55 is provided, (FIG. 6), and which couples a controller, as will be described, hereinafter, in controlling relation relative to the respective sensors 51 and 52, respectively.

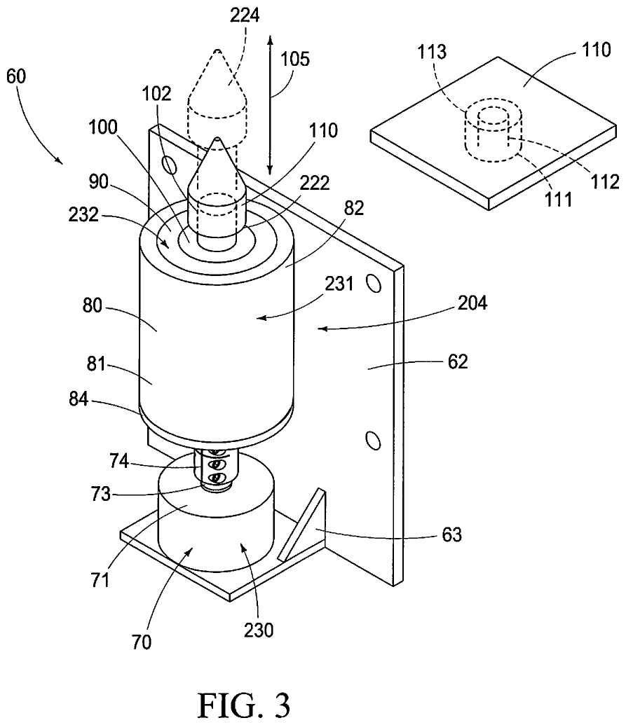

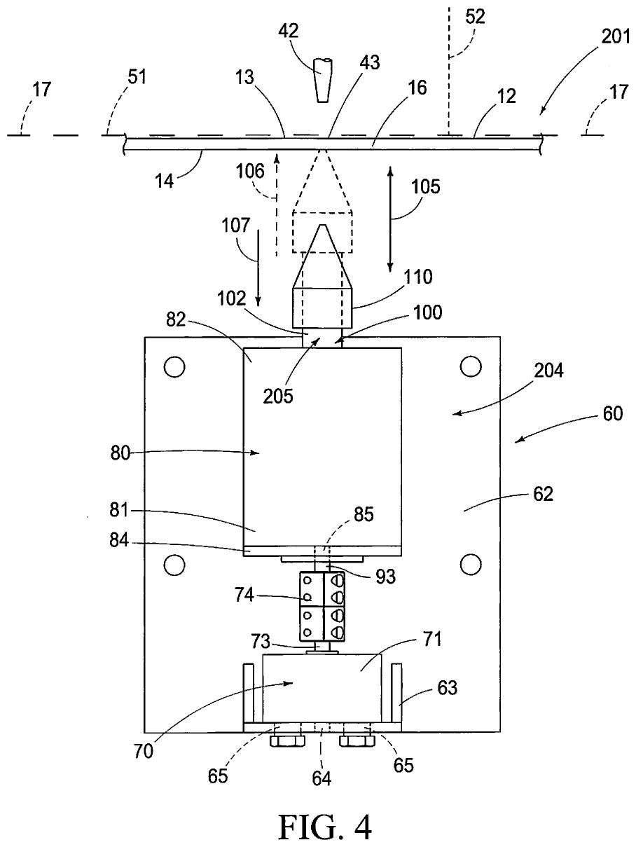

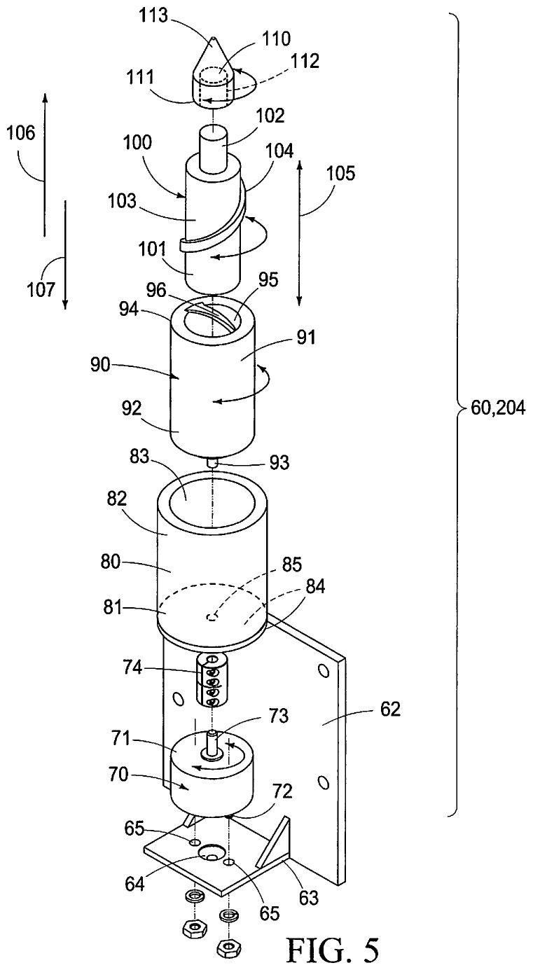

As seen in the drawings, and more specifically to FIGS. 3, 4 and 5, the present apparatus 10 includes a multiplicity of orientation units which are generally indicated by the numeral 60, and which are further mounted on and within the frame 20. The respective orientation units 60 are further selectively adjustable, as to length, so as to individually position, and maintain the object of interest 11 to be severed in the predetermined planar orientation 17, while being severed by the cutting assembly 40. This is best understood by a study of FIG. 4. As seen in FIG. 2, a multiplicity of transversely disposed, and spaced support members 61 are positioned within the internal cavity 24 of the frame 20, and extend between the opposite, peripheral sidewalls 21. The respective support member 61 provide locations upon which individual orientation units 60 may be secured in predetermined, spaced relation, one relative to the others. In one possible form of the invention 10, the respective orientation units 60 are spaced, one from another, at a distance of about ______ to about ______ inches. As seen in FIG. 3, and following, the given orientation units 60 each include a mounting plate 62, and which is fastened in given locations along the respective transversely spaced support members 61. The mounting plate further includes a motor support bracket 63. As seen in the exploded view of FIG. 5, the motor support bracket 63 has an electrical conduit aperture 64 formed therein, and further includes fastener apertures 65 which allows an electrical motor to be releasably attached thereto. The electrical motor will be discussed in the paragraphs which follow.

It should be understood from studying the exploded view of FIG. 5 that the present apparatus 10 includes a selectively actuatable or energizable electrical motor 70. The electrical motor further has a motor body 71, bearing threaded couplers 72, and which are further matingly received within the respective fastener apertures 65, and which are formed in the motor support bracket 63. The electrical motor 70 is of a conventional design, and has a rotatable drive shaft 73 which, when selectively energized, can be rotated in a predetermined direction. Still further, the present invention 10 includes a drive shaft coupler 74 which is releasably attached to the rotatable drift shaft 73, and which is further operable to also matingly couple to a drive shaft, of a drive sleeve, as will be described in greater detail below. As seen in FIG. 6, an electrical pathway 75 couples the motor body 71 in a controllable relationship relative to a controller, as will be discussed in further detail with regards to FIG. 6.

As seen in FIGS. 4 and 5, the respective orientation units 60 include a cylindrically shaped housing, and which is generally indicated by the numeral 80, and which is further positioned or mounted in spaced relation relative to the drive shaft coupler 74, as described in the paragraph, above. The cylindrically shaped housing 80 has a first end 81, and an opposite, second end 82. Still further, the cylindrically shaped housing 80 defines a cylindrically shaped internal cavity 83 which extends from the second end 82, in the direction of the first end 81. Still further, and as seen in the side elevation view of FIG. 4, an end plate 84 is provided, and which partially occludes the first end 81 of the cylindrically shaped housing 80. The end plate 84 has a passageway 85 which is formed therein, and which allows or permits the passage of a drive shaft which is mounted on a drive sleeve as will be described, hereinafter. The cylindrically shaped housing 80 generally orients the respective orientation units 60 in a generally vertically upward direction. The cylindrically shaped internal cavity 83 has a predetermined cross-sectional dimension which will be discussed, below.

The respective orientation units 60 each include a drive sleeve which is generally indicated by the numeral 90. The respective drive sleeves 90 each have a generally elongated and cylindrically shaped main body 91 which has a reduced cross-sectional dimension which permits the drive sleeve 90 to be telescopingly, and rotatably received within the cylindrically shaped internal cavity 83, and which is defined by the cylindrically shaped housing 80. The elongated main body 91 has a first end 92 which mounts a coaxially aligned drive shaft 93. The drive shaft 93 is received through the passageway 85 which is formed in the end plate 84 of the cylindrically shaped housing 80. Still further, this drive shaft 93 is then releasably secured within the drive shaft coupler 74. This coaxially orients the drive shaft 73 with the drive shaft 93. Consequently, an energizing of the electrical motor 70, and which causes a corresponding rotation of the drive shaft 73, imparts a corresponding coaxial rotation relative to the drive shaft 93. This simultaneous rotation of the drive shaft 93 imparts coaxial rotational movement of the elongated main body 91 within the cylindrically shaped internal cavity 83. The drive sleeve 90 has a second end 94, and a cylindrically shaped internal cavity 95 is defined by the elongated main body 91, and extends from the second end 94, in the direction of the first end 92. The cylindrically shaped internal cavity 95 has a given cross-sectional dimension. Still further, and as seen in FIG. 5, the internal cavity defines an internal screw thread 96 which is oriented within the internal cavity 95, and which is useful for moving an elongated actuator, as will be described in the paragraphs which follow, in a coaxial path of movement either coaxially outwardly, or coaxially inwardly, relative to the cylindrically shaped internal cavity 95.

Still referring to FIGS. 3, 4 and 5 the respective orientation units 60 each include an elongated, generally cylindrically shaped actuator which is indicated by the numeral 100, and which is further telescopingly and threadably received within the cylindrically shaped internal cavity 95, as defined by the drive sleeve 90. The cylindrically shaped actuator 100 has a first end 101, and an opposite, second end 102, and which further has a reduced cross-sectional dimension. Still further, the cylindrically shaped actuator has an exterior facing surface 103 which defines, at least in part, an exterior facing and radially outwardly extending screw thread 104. The screw thread 104 is sized and shaped so as to threadably and matingly be received within, and cooperate with the internal screw thread 96 which is formed within the elongated main body 91, of the drive sleeve 90, and which is further accessible from the cylindrically shaped internal cavity 95 thereof. The screw threadable mating receipt and cooperation of the screw thread 104, with the internal screw thread 96 is effective, so as to cause precisely controllable, coaxial, reciprocal movement of the actuator 100 along a given path of movement 105, either in a coaxial outward direction 106 relative to the drive sleeve 90; or coaxially inwardly 107 relative to the cylindrically shaped internal cavity 95, based upon the direction of rotation of the drive sleeve 90 as may be imparted to same by means of the electrical motor 70 when it is selectively energized by the controller 120 as seen in FIG. 6.

The controller 120 is electrically coupled to the electrical motor 70, as earlier discussed, and further is electrically coupled with each of the respective sensors 50, and cutting device 40, as well as the movable gantry 30 (FIG. 6). Therefore, it should be understood that when the controller 120 imparts predetermined rotation to the drive sleeve 90 by selectively energizing the electric motor 70, the energizing of the electric motor 70 is effective in screw threadably moving the elongated actuator 100 either coaxially outwardly 106; or coaxially inwardly 107, relative to the drive sleeve 90 so as to change an overall length dimension of the respective orientation units 60. This is seen clearly by reference to FIG. 4. In particular the controller 120 is operably and controllably coupled with each of the cutting device 40, multiplicity of orientation units 60, and moveably gantry 30 so as to effect an optimal severing of the object of interest 11 while maintaining the object of interest 11 in the predetermined planar orientation 17 on the frame 20. As seen in FIG. 4, the controller 120 is further operable to simultaneously and selectively displace the individual orientation units 60 from a supporting position below a region 43 of the object of interest 11, and where the cutting device 40 is currently severing the object of interest. This removal or displacement of the respective orientation devices 60 from a supporting relationship below the object of interest 11 being severed insures that an object engagement member 110 which has a first end 111, and which is further mounted on the second end 102 of the elongated generally cylindrically shaped actuator 100 by means of a cavity 112 which is formed in the first end 111, remains undamaged as a result of the severing activity. As seen in the drawings, the second end 113 of the object engaging member 110 engages the object of interest 11 but in view of the physical arrangement as shown in FIG. 4, the object engagement member 110 freely rotates relative to the elongated generally cylindrically shaped actuator 100 so as to prevent friction related damage from occurring to the bottom surface 14 of the continuous sheet 12 which is formed from the object of interest 11. This spatial displacement also prevents, to some degree, the object engaging member 110 from becoming coated with debris which might be generated by way of the cutting process. As can be seen, and appreciated from a study of the attached drawings (FIG. 3), variously shaped object engagement members 110 can be fabricated to freely rotate about the elongated generally cylindrically shaped actuator 100 at the second end 102 thereof.

The present invention also includes a method 200 for supporting and severing an object of interest. The method 200 includes as a first step 201 of providing a source of an object of interest 11 to be severed. Still further the method 200 includes another step 202 of providing a frame 20 which has top and bottom surfaces, and a peripheral sidewall 21, and which further defines the internal cavity 24, and further supporting 203 at least a portion of the source of the object of interest 11 to be severed in a given, predetermined planar orientation 17 relative to the top surface 13 of the frame 20. The method 200 of the present invention includes another step 204 of providing a multiplicity of orientation units 60, and spatially positioning the respective orientation units 60 in predetermined locations within the internal cavity 24 of the frame 20, and wherein the respective orientation units 60 each include an elongated, generally cylindrically shaped, and selectively, mechanically movable actuator 100, 205 which supports, at least in part, a discreet region 43 of the object of interest 11, and which is positioned on the frame 20. The method 200 of the present invention includes another step 210 of providing a gantry 30, and movably mounting the gantry 30 for travel along a first path of travel 34 relative to the frame 20, and in predetermined, spaced relation relative to the top surface 13 of the frame 20. The method 200 further includes another step 211 of movably mounting a cutting device 40 on the movable gantry 30, and then rendering the cutting device selectively movable along a second, predetermined path of travel 41 which is transverse to the first predetermined path of travel 34. The method 200 of the present invention includes another step 212 of positioning a plurality of sensors 50 on the frame 20 and/or movable gantry 30, and sensing with the respective sensors 50 the vertical and horizontal position of at least one of the regions 43 of the object of interest 11, and which is supported on the frame 20. The method 200 includes another step 213 of providing a controller 120, and controllably coupling the controller 120 to each of the multiplicity of orientation units 60; the movable gantry 30; the cutting device 40; and the respective sensors 50.

The method 200 includes another step 214 of sensing, with the sensors 50 the horizontal and vertical position of the object of interest 11, and supplying the horizontal and vertical position of the object of interest 11 to the controller 120. The method 200 includes still another step 215 of selectively energizing the respective orientation units 60 by way of the controller 120, to adjustably effect, and then maintain, the position of the object of interest 11 in the given predetermined planar orientation 17 on the frame 20 by selectively moving the actuator 100, of individual orientation units 60, so as to impart force to the object of interest 11, and thereby position the object of interest 11 in the predetermined planar orientation 17. The method 200 of the present invention includes another step 220 of controllably compelling the gantry 30 along the first course of travel 34 to a given location as determined by the controller 120. The method 200 of the present invention includes another step 221 of controllably propelling the cutting device 40 along the second course of travel 41 to a given region 43, of the object of interest 11, and which is to be severed as determined by the controller 120. The method 200 of the present invention includes another step 222 of controllably withdrawing by means of the controller 120, the actuator 100 of the individual orientation units 60, and which are supporting the object of interest 11, and which are further located in a predetermined vicinity of the region 43 of the object of interest 11 which is to be severed, and positioning the respective actuators 100 in spaced relation relative to the region 43 which is being severed. The method 200 includes another step 223 of selectively, and operably energizing the cutting assembly 40 by way of the controller 120, and severing the object of interest 11 in a predetermined pattern in the region 43 of the object of interest 100 as determined by the controller 120 by simultaneously, and controllably propelling the gantry 30 along the first course of travel 34, and the cutting assembly 40 along the second course of travel 41. Further, the method 200 of the present invention includes another step 224, which occurs after the step of severing the object of interest, of selectively and controllably repositioning, by means of the controller 120, the actuator 100 of selective, individual orientation units 60 which were previously withdrawn, and located in spaced relation relative to the region 43 of the object of interest 11 which was previously severed, so as to maintain the object of interest 11 in the predetermined planar orientation 17 relative to the frame 20.

The method 200 of the present invention, as described, above, further includes another step 230 of providing a selectively energizable electric motor 70 which is controllably coupled to the controller 120, and which further has a selectively rotatable drive shaft 73. The method 200 further includes another step 231 of providing a cylindrically shaped housing 80, having opposite first and second ends 81 and 82, in a coaxially orientation relative to the to the drive shaft 73, and wherein the cylindrically shaped housing 80 further defines a cylindrically shaped internal cavity 83 which extends between the first and second ends thereof. The method 200 of the present invention further includes a step 232 of providing a drive sleeve 90, and telescoping and rotatably positioning the drive sleeve 90 within the internal cavity 83 of the cylindrically shaped housing 80, and wherein the drive sleeve 90 has a first and second end 92 and 94, and further is drivingly coupled by way of a drive shaft 93, to the drive shaft 73 of the selectively energizable electric motor 70. As discussed, earlier, the drive sleeve 90 further defines a cylindrically shaped internal cavity 95 extending from the second end 94, and in the direction of the first end 92 thereof, and wherein the drive sleeve 90 further defines an internal screw thread 96 which is oriented within the cylindrically shaped internal cavity 95. The method 200 of the present invention includes another step 233 of selectively energizing the selectively energizable electric motor 70 by way of the controller 120 so as to effect a coaxial rotation of the drive sleeve 90 in a predetermined direction within the internal cavity 83 of the cylindrically shaped housing 80. Still further, the method 200 includes another step of providing 205 an elongated, generally cylindrically shaped actuator 100 having opposite first and second ends 101 and 102, and an exterior facing surface 103 which defines an outward facing a screw thread 104 which matingly and threadably cooperates with the internal screw thread 96 which is defined by the drive sleeve 90, and telescopingly positioning the elongated generally cylindrically shaped actuator 100 within the internal cavity 95 which is defined by the drive sleeve 90. The method 200 further includes a step of providing a predetermined rotation to the drive sleeve 90 by the selective energizing of the electric motor 70 with the controller 120, and which is effective to screw threadably move the elongated actuator 100 either coaxially outwardly 106, or coaxially inwardly 107 relative to the drive sleeve 90 so as to change an overall length dimension of the respective orientation units 60, and thereby effect the supporting of the object of interest 11 in the predetermined planar orientation 17 relative to the frame 20.

### Operation

The operation of the present invention is believed to be readily apparent and is briefly summarized at this point.

In its broadest aspect, the present invention relates to an apparatus 10 for supporting and severing an object of interest 11, and which includes providing a frame 20 for positioning the object of interest 11 which is to be severed, in a given, predetermined, planar orientation 17. The apparatus 10 further includes, in its broadest aspect, a cutting device 40 which is selectively, and movably mounted in spaced relation relative to the frame 20, and which further, when rendered operable, severs the object of interest 11 which is positioned in the predetermined, planar orientation 17, on the frame 20. The apparatus 10 in its broadest aspect also includes a multiplicity of orientation unit 60 which are mounted on the frame 20, and which are further selectively, and mechanically adjustable, as to length, so as to individually position, and maintain, the object of interest 11 to be severed, in the predetermined, planar orientation 17, while being severed. Further, and in its broadest aspect, the present invention 10 includes a controller 120 which is operably coupled with each of the cutting device 40, and the multiplicity of orientation units 60, so as to effect an optimal severing of the object of interest 11, while maintaining the object of interest 11 in the predetermined planar orientation 17 on the frame 20, and which further, simultaneously and selectively displaces the individual orientation units 60 from a supporting position relative to a region 43 of the object of interest 11, and where the cutting device 40 is currently severing the object of interest 11.

As noted above, the apparatus 10 includes a frame 20 which further has top and bottom surfaces 22 and 23, respectively, and which is further defined, at least in part, by a peripheral sidewall 21. The frame 20 defines an internal cavity 24, and which is further located between the top and bottom surfaces 22 and 23, of the peripheral sidewall 21. The multiplicity of orientation units 60 are mounted in a predetermined pattern within the internal cavity 24 of the frame 20, and are further positioned between the peripheral sidewalls 21, of the frame 20.

As seen in the drawings the apparatus 10 of the present invention further includes a plurality of sensors 50, which are mounted on the frame 20, and which are further rendered operable to sense the given planar orientation 17 of the object of interest 11, as it rests on the frame 20, and is positioned between the frame 20 and the cutting device 40, respectively. Still further, it should be understood that the plurality of sensors 50, in one form of the invention, are optical sensors, and which sense the horizontal and/or vertical position of the object of interest 11, and which is located on the frame 20, and located in the given planar orientation 17. In another possible form of the invention the plurality of sensors may include both optical, as well as mechanical sensors for performing the same task. As seen in the drawings, and in one form of the invention, the apparatus 10 includes a gantry 30, which is borne by the frame 20, and which further is selectively movable along a predetermined, first course of travel 34 relative to the frame 20. The cutting device 40 is mounted on the gantry 30, and is further, selectively movable along the gantry 30, and in a predetermined second course of travel 41 which is transverse to the first course of travel 34 of the gantry 30. The cutting device 40, when rendered operational, severs the object of interest 11 which is located on the frame 30, and is positioned between the frame 30, and the cutting device 40, which is mounted on the gantry 30. The controller 120 is operable to control the position of each of the gantry 30, and the cutting device 40, and which is further selectively movable along the gantry 30 so as to facilitate the severing of the object of interest 11 in a given pattern as provided by electrical signal or other instructions received from the controller 120. The apparatus 10 of the present invention, and more specifically the orientation units 60, thereof, include a selectively energizable electric motor 70 which is controllably coupled to the controller 120, and which further has a selectively rotatable drive shaft 73. In this regard, the respective orientation units 60 further includes a cylindrically shaped housing 80 which has opposite, first and second ends 81 and 82, respectively, and which is further coaxially oriented relative to the drive shaft 73. The cylindrically shaped housing 80 further defines a cylindrically shaped internal cavity 83 which extends between the first and second ends 81 and 82, thereof. The respective orientation units 60 further include a drive sleeve 90 which is telescopingly and rotatably received within the internal cavity 83 of the cylindrically shaped housing 80. The drive sleeve 90 has a first end 92 which is drivingly coupled to the drive shaft 73 of the selectively energizable electric motor 70, and an opposite second end 94. The drive sleeve 90 further defines a cylindrically shaped internal cavity 95 extending from the second end 94, and in the direction of the first end 92 thereof. The drive sleeve 90 further defines an internal screw thread 96 which is oriented within the cylindrically shaped internal cavity 95. As should be understood, upon a selective energizing 233 of the selectively energizable motor 70, the drive sleeve 90 coaxially rotates in a predetermined direction within the internal cavity 83 of the cylindrically shaped housing 80. As should be further understood from a study of the drawings, the respective orientation units 60 each further include an elongated, generally cylindrically shaped actuator 100 having opposite first and second ends 101 and 102, respectively, and which further has an exterior facing surface 103, and which additionally defines an outwardly facing screw thread 104. The screw thread 104 further matingly and threadably cooperates with the internal screw thread 96 which is defined by the drive sleeve 90. As will be appreciated, and as earlier discussed, a predetermined rotation of the drive sleeve 90 by the selective energizing 233 of the electric motor 70, is effective in screw-threadably moving or otherwise urging the elongated actuator 100 either coaxially outwardly 106, or coaxially inwardly 107, relative to the drive sleeve 90 so as to change an overall length dimension of the orientation unit 60.

As described in the paragraph immediately, above, the elongated, cylindrically shaped actuator 100 has a predetermined maximum cross-sectional dimension, and the apparatus 10 further includes an object engaging member 110 which is mounted on the second end 102, of the elongated cylindrically shaped actuator 100. The object engaging member 110 has a cross sectional dimension which is greater than the cross sectional dimension of the elongated, cylindrically shaped actuator 100. Still further, and in one possible form of the invention, the object engagement member 110 is rotatably movable relative to the second end 102 of the elongated cylindrically shaped actuator 100. This feature prevents friction related damages from occurring upon rotation of the elongated cylindrically shaped actuator 100. It should be understood the respective orientation units 60 are spaced, one from another, at a distance of about ______ to about ______ inches.

More specifically the present invention 10 relates to an apparatus for supporting and severing an object of interest 11, and which includes a frame 20 for positioning an object of interest 11 which is to be severed in a given planar orientation 17. The apparatus further includes a gantry 30 which is borne by the frame 20, and which is selectively movable along a predetermined, first course of travel 34 relative to the frame 20. In one form of the invention the present apparatus 10 includes a cutting device 40 which is mounted on the gantry 30, and which is further selectively movable along the gantry, and in a predetermined, second course of travel 41, which is transverse to the first course of travel 34, of the gantry 30. The cutting device 40, when rendered operational, severs the object of interest 11 which is located on the frame 20, and positioned between the frame 20, and the cutting device 40 which is movably mounted on the gantry 30. It should be understood that the present apparatus 10 includes a plurality of sensors 50 which are mounted on the frame 20, and which are further rendered operable to sense the given planar orientation 17 of the object of interest 11, relative to each of the frame 30, and the cutting device 40, respectively. Still further, the present apparatus 10 includes a multiplicity of orientation units 60 which are mounted on the frame 20, and which are further selectively adjustable, as to length, so as to individually position, and maintain the object of interest 11 to be severed in the predetermined planar orientation 17 while being severed. Still further, the invention 10 includes a controller 120 which is operably coupled with each of the movable gantry 30, cutting device 40, respective sensors 50, and multiplicity of orientation units 60, so as to effect an optimal severing of the object of interest 11 while maintaining the object of interest in the predetermine planar orientation 17 on the frame 20, and simultaneously withdrawing 222 individual orientation units 60 from a supporting orientation relative to a region 43 of the object of interest 11 where the cutting device is severing the object of interest 11 (FIG. 4).

Therefore, it will be seen that the present apparatus and method for supporting and severing an object of interest provides many conveniences and advantages which are not provided by the prior art devices and methodology which have been employed, heretofore, in the severing of objects of interest such as sheet material as is illustrated, and described in the present application. The present invention is easy to operate, convenient, reliable, and provides resulting precision cuts in objects of interest 11 which have not been achievable using the prior art teachings and devices known, heretofore.

In compliance with the statute the invention has been described in language more or less specific as to structural and methodological features. It is to be understood, however, that the invention is not limited to the specific features shown, and described, since the means herein disclosed comprise preferred forms of putting the invention into effect. The invention is, therefore, claimed in any of its forms or modifications within the proper scope of the appended claims appropriately interpreted in accordance with the Doctrine of Equivalence.

I claim:

1. An apparatus for supporting and severing an object of interest, comprising:
a frame for positioning an object of interest, which is to be severed, in a given, predetermined, planar orientation;
a cutting device which is selectively, and moveably mounted in spaced relation relative to the frame, and which, when rendered operable, severs the object of interest which is positioned in the predetermined, planar orientation on the frame;
a multiplicity of orientation units which are mounted on the frame, and which are further selectively, and mechanically adjustable, as to length, so as to individually position, and maintain the object of interest to be severed in the predetermined, planar orientation while being severed; and
a controller, operably coupled with each of the cutting device, and multiplicity of orientation units, so as to effect an optimal severing of the object of interest while maintaining the object of interest in the predetermined planar orientation on the frame, and which further simultaneously, and selectively displaces the individual orientation units from a supporting position relative to a region of the object of interest where the cutting device is currently severing the object of interest.

2. An apparatus as claimed in claim 1, and wherein the frame has a top and bottom surface, and a peripheral sidewall, and wherein the frame defines an internal cavity which is defined between the top and bottom surfaces, and the peripheral sidewall, and wherein the multiplicity of orientation units are mounted in a predetermined pattern within the internal cavity of the frame, and the object of interest is supported on the respective orientation units, and is further positioned between the peripheral sidewalls of the frame.

3. An apparatus as claimed in claim 2, and further comprising:
a plurality of sensors mounted on the frame, and which are further rendered operable to sense the given planar orientation of the object of interest relative to each of the frame, and the cutting device, respectively.

4. An apparatus as claimed in claim 3, and wherein the plurality of sensors are optical sensors which sense the horizontal and/or vertical position of the object of interest when the object of interest is in the given planar orientation.

5. An apparatus as claimed in claim 3, and further comprising:
a gantry borne by frame, and which is selectively moveable along a predetermined, first course of travel relative to the frame, and wherein the cutting device is mounted on the gantry, and is further selectively moveable along the gantry, and in a predetermined, second course of travel which is transverse to the first course of travel of the gantry, and wherein the cutting device, when rendered operational, severs the object of interest which is located on the frame, and positioned between the frame, and the cutting device mounted on the gantry, and wherein the controller is operable to controllably position each of the gantry, and the cutting device which is selectively moveable along the gantry.

6. An apparatus as claimed in claim 3, and wherein the respective orientation units further comprise:
a selectively energizable electric motor which is controllably coupled to the controller, and which further has a selectively rotatable drive shaft;
a cylindrically shaped housing having opposite, first and second ends, and which is coaxially oriented relative to the drive shaft, and wherein the cylindrically shaped housing further defines a cylindrically shaped internal cavity which extends between the first and second ends thereof;
a drive sleeve which is telescopingly, and rotatably received within the internal cavity of the cylindrically shaped housing, and wherein the drive sleeve has a first end which is drivingly coupled to the drive shaft of the selectively energizable electric motor, and an opposite, second end, and wherein the drive sleeve further defines a cylindrically shaped internal cavity extending from the second end, and in the direction of the first end, thereof, and wherein the drive sleeve further defines an internal screw thread which is oriented within the cylindrically shape internal cavity, and wherein upon an energizing of the selectively energizable electric motor, the drive sleeve coaxially rotates in a predetermined direction within the internal cavity of the cylindrically shaped housing; and
an elongated, generally cylindrically shaped actuator having opposite, first and second ends, and an exterior facing surface which defines a screw thread, and which further matingly and threadably cooperates with the internal screw thread which is defined by the drive sleeve, and wherein a predetermined rotation of the drive sleeve by the energizing of the electric motor is effective in screw threadably moving the elongated actuator either coaxially outwardly, or coaxially inwardly relative to the drive sleeve so as to change an overall length dimension of the orientation unit.

7. An apparatus as claimed in claim 6, and wherein the elongated, cylindrically shaped actuator has a predetermined, maximum cross-sectional dimension, and the apparatus further includes an object engaging member which is mounted on the second end of the elongated, cylindrically shaped actuator, and which further has a cross-sectional dimension which is greater than the cross-sectional dimension of the elongated, cylindrically shaped actuator.

8. An apparatus as claimed in claim 7, and wherein the object engagement member is rotatably moveable relative to the second end of the elongated, cylindrically shaped actuator.

9. An apparatus as claimed in claim 8, and wherein the respective orientation units are spaced, one from another, at a distance of about ______ to about ______ inches.

10. An apparatus for supporting and severing an object of interest, comprising:
a frame for positioning an object of interest, which is to be severed, in a given planar orientation;
a gantry borne by frame, and which is selectively moveable along a predetermined, first course of travel relative to the frame;
a cutting device mounted on the gantry, and which is further selectively moveable along the gantry, and in a predetermined, second course of travel which is transverse to the first course of travel of the gantry, and wherein the cutting device, when rendered operational, severs the object of interest which is located on the frame, and positioned between the frame, and the cutting device which is movably mounted on the gantry;
a plurality of sensors mounted on the frame, and which are further rendered operable to sense the given planar orientation of the object of interest relative to each of the frame, and the cutting device, respectively;
a multiplicity of orientation units which are mounted on the frame, and which are further selectively adjustable as to length so as to individually position, and maintain the object of interest to be severed in the predetermined planar orientation while being severed; and
a controller, operably coupled with each of the moveable gantry, cutting device, respective sensors, and multiplicity of orientation units, so as to effect an optimal severing of the object of interest while maintaining the object of interest in the predetermined planar orientation on the frame, and simultaneously withdrawing individual orientation units from a supporting orientation relative to a region of the object of interest, and where the cutting device is severing the object of interest.

11. An apparatus as claimed in claim 10, and wherein the object of interest is at least partially flexible, and has a top and bottom surface, and is defined by smaller regions which are severed by the operation of the cutting device, and wherein the sensors are rendered operable to detect the vertical and horizontal position of the smaller regions of the partially flexible object of interest as the cutting device severs the smaller regions.

12. An apparatus as claimed in 10, and wherein the sensors are borne by the frame and further include optical and/or mechanical sensors.

13. An apparatus as claimed in claim 12, and wherein at least some of the sensors are mounted on the moveable gantry.

14. An apparatus as claimed in claim 10, and wherein the object of interest includes a substantially continuous sheet of rigid, yet partially flexible material.

15. An apparatus as claimed in claim 10, and wherein the cutting device generates a high pressure fluid stream which severs the object of interest.

16. An apparatus as claimed in claim 10, and wherein the cutting device is a thermal cutting tool which severs the object of interest.

17. An apparatus as claimed in claim 10, and wherein the respective orientation units further comprise:
a selectively energizable electric motor which is controllably coupled to the controller, and which further has a selectively rotatable drive shaft;
a cylindrically shaped housing having opposite, first and second ends, and which is coaxially oriented relative to the drive shaft, and wherein the cylindrically shaped housing further defines a cylindrically shaped internal cavity which extends between the first and second ends thereof;
a drive sleeve which is telescopingly, and rotatably received within the internal cavity of the cylindrically shaped housing, and wherein the drive sleeve has a first end which is drivingly coupled to the drive shaft of the selectively energizable electric motor, and an opposite, second end, and wherein the drive sleeve further defines a cylindrically shaped internal cavity extending from the second end, and in the direction of the first end, thereof, and wherein the drive sleeve further defines an internal screw thread which is oriented within the cylindrically shape internal cavity, and wherein upon the energizing of the selectively energizable electric motor, the drive sleeve coaxially rotates in a predetermined direction within the internal cavity of the cylindrically shaped housing; and
an elongated, generally cylindrically shaped actuator having opposite, first and second ends, and an exterior facing surface which defines a screw thread, and which further matingly and threadably cooperates with the internal screw thread which is defined by the drive sleeve, and wherein a predetermined rotation of the drive sleeve by the energizing of the electric motor is effective in screw threadably moving the elongated actuator either coaxially outwardly, or coaxially inwardly relative to the drive sleeve so as to change an overall length dimension of the orientation unit.

18. An apparatus as claimed in claim 17, and wherein the elongated, cylindrically shaped actuator has a predetermined, maximum cross-sectional dimension, and the apparatus further includes an object engaging member which is mounted on the second end of the elongated, cylindrically shaped actuator, and which further has a cross-sectional dimension which is greater than the cross-sectional dimension of the elongated, cylindrically shaped actuator.

19. A method for supporting and severing an object of interest, comprising:
providing a source of an object of interest to be selectively severed;
providing a frame which has top and bottom surfaces, and a peripheral sidewall, and which further defines an internal cavity, and supporting at least a portion of the source of object of interest to be severed in a given, predetermined planar orientation relative to the top surface of the frame;
providing a multiplicity of orientation units, and spatially positioning the respective orientation units in predetermined locations within the internal cavity of the frame, and wherein the respective orientation units each include an elongated, generally cylindrically shaped, and selectively, mechanically moveable, actuator which supports, at least in part, a discrete region of the object of interest which is positioned on the frame;
providing a gantry, and moveably mounting the gantry for travel along a first path of travel relative to the frame, and in predetermined, spaced relation relative to the top surface of the frame;
moveably mounting a cutting device on the moveable gantry, and rendering the cutting device selectively moveable along a second, predetermined path of travel which is transverse to the first predetermined path of travel;
positioning a plurality of sensors on the frame and/or moveable gantry, and sensing with the respective sensors the vertical and horizontal position of at least one of the regions of the object of interest which is supported on the frame;
providing a controller, and controllably coupling the controller to each of the multiplicity of orientation units; the moveable gantry; the cutting device, and the respective sensors;
sensing with the sensors the horizontal and vertical position of the object of interest, and supplying the horizontal and vertical position of the object of interest to the controller;
selectively energizing the respective orientation units, by way of the controller, to adjustably effect, and then maintain the position of the object of interest in the given, predetermined planar orientation on the frame by selectively moving the actuator of individual orientation units so as to impart force to the object of interest, and thereby position the object of interest in the predetermined planar orientation;
controllably propelling the gantry along the first course of travel to a given location as determined by the controller;
controllably propelling the cutting device along the second course of travel to a given region of the object of interest which is to be severed, as determined by the controller;
controllably withdrawing, by means of the controller, the actuator of individual orientation units which are supporting the object of interest, and which are further located in a predetermined vicinity of the region of the object of interest which is to be severed, and positioning the respective actuators in spaced relation relative to region which is to be severed;
selectively and operably energizing the cutting assembly by way of the controller, and severing the object of interest in a predetermined pattern in the region of the object of interest as determined by the controller by simultaneously, and controllably propelling the gantry along the first course of travel, and the cutting assembly along the second course of travel; and
after the step of severing the object of interest, selectively, and controllably repositioning, by means of the controller, the actuator of individual orientation units which were previously withdrawn, and located in spaced relation relative to the region of the object of interest which was previously severed, so as to maintain the object of interest in the predetermined planar orientation relative to the frame.

20. A method as claimed in claim 19, and wherein the step of providing a multiplicity of orientation units further comprises:
providing a selectively energizable electric motor which is controllably coupled to the controller, and which further has a selectively rotatable drive shaft;
providing a cylindrically shaped housing having opposite, first and second ends, and coaxially orienting the housing relative to the drive shaft, and wherein the cylindrically shaped housing further defines a cylindrically shaped internal cavity which extends between the first and second ends thereof;
providing a drive sleeve and telescopingly, and rotatably positioning the drive sleeve within the internal cavity of the cylindrically shaped housing, and wherein the drive sleeve has a first and second end, and drivingly coupling the first end of the drive sleeve to the drive shaft of the selectively energizable electric motor, and wherein the drive sleeve further defines a cylindrically shaped internal cavity extending from the second end, and in the direction of the first end, thereof, and wherein the drive sleeve further defines an internal screw thread which is oriented within the cylindrically shape internal cavity;
selectively energizing of the selectively energizable electric motor, by way of the controller, so as to effect a coaxially rotation of the drive sleeve in a predetermined direction within the internal cavity of the cylindrically shaped housing; and
providing an elongated, generally cylindrically shaped actuator having opposite, first and second ends, and an exterior facing surface which defines a screw thread which matingly and threadably cooperates with the internal screw thread which is defined by the drive sleeve, and telescopingly positioning the elongated, generally cylindrically shape actuator within the internal cavity which is defined by the drive sleeve, and wherein a predetermined rotation of the drive sleeve by the selective energizing of the electric motor with the controller is effective to screw-threadably move the elongated actuator either coaxially outwardly, or coaxially inwardly relative to the drive sleeve so as to change an overall length dimension of the orientation unit and effect the supporting of the object of interest in the predetermined planar orientation relative to the frame.
